(19) United States
(12) Patent Application Publication
(10) Pub. No.: US 2005/0233209 A1
(43) Pub. Date: Oct. 20, 2005

(54) Electrical contact for current collectors of electrochemical cells and method therefor

(76) Inventors: Anthony Sudano, Laval (CA); Michel Parent, St-Jean-sur-Richelieu (CA); Jacques Beauchamp, Laprairie (CA); Richard Laliberte, Ste-Julie (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/826,400

(22) Filed: Apr. 19, 2004

(51) Int. Cl. H01M 2/24; H01B 5/00

(52) U.S. Cl. 429/160; 29/623.1; 174/126.1

(57) ABSTRACT

An electrical contact for connecting current collecting elements of a stack of electrochemical laminates. The electrical contact is formed of a current collecting terminal and a ductile electrically conductive material. The current collecting terminal has a pair of arms defining a space therebetween for receiving the ends of the current collecting elements as stacked. The ductile electrically conductive material is located within the space and is adapted to form an electrical bridge between the ends of the current collecting elements and the current collecting terminal.

### FIELD OF THE INVENTION

The present invention relates generally to polymer electrolyte batteries. More particularly, the present invention relates to electrical contacts for current collectors consisting of a metal or metal oxide layer on a plastic substrate film, for use in polymer electrolyte batteries.

### BACKGROUND OF THE INVENTION

Rechargeable batteries manufactured from laminates of solid polymer electrolytes and sheet-like anodes and cathodes display many advantages over conventional liquid electrolyte batteries. These advantages include having a lower overall battery weight, a higher power density, a higher specific energy and a longer service life, as well as being environmentally friendly since the danger of spilling toxic liquid into the environment is eliminated. Solid polymer battery components include positive electrodes, negative electrodes and an electrolyte separator capable of permitting ionic conductivity, such as a solid polymer electrolyte mixed with an alkali salt sandwiched between the electrodes. The anode or negative electrode is usually made of alkali metal and alloys, typically Lithium metal, lithium alloys and the like or carbon, such as coke or graphite intercalated with lithium ion to form LiₓC. The composite cathode or positive electrode is usually formed of a mixture of an active material (such as a transitional metal oxide), an electronically conductive filler (usually carbon or graphite particles), an ionically conductive polymer electrolyte material, an alkali salt and a current collector (usually a thin sheet of aluminum).

Composite cathode thin films are usually obtained by coating or extruding directly onto a current collector. The current collector conducts the flow of electrons between the cathode active material and the battery terminals and also provides support for the cathode material, which has a paste-like structure. Current collectors such as metal foils have a tendency to corrode or to form an insulating film, which impairs the passage of electrons between the collector and the active material of the electrode when in direct contact with the cathode active material, thereby increasing the internal resistance of the electrochemical cell and reducing power density and cycle life of such rechargeable batteries. Corrosion of the metal current collector often occurs when very thin current collectors are used. This corrosion leads to loss of contact, electronic isolation and poor battery performance. It is known to use a protective coating between the electrode material and the metal current collector in order to enhance the contact and adhesion of the electrode material to the metal current collector. Such a protective coating also serves to protect the current collector from the corrosive effects of the electrolyte, the anodic material and the cathodic material.

The current collector is considered as a passive component of the electrochemical cell because it does not generate energy but simply provides a means for conducting electrical current generated by the electrochemical cell. One exception is the use of a lithium or lithium alloy metal anode, which is an active component of the electrochemical cell and fully capable of conducting electrical current. It is therefore imperative to reduce the volume and weight of the current collector to a minimum for a given application.

Thin metallic foil current collectors are fragile and have a tendency to break when subjected to tension through the various manufacturing processes of producing electrochemical cells. Every breakage of the metallic current collector effectively interrupts the production process, thereby increasing cost by reducing efficiency. To alleviate this problem, thin current collectors need to be less fragile and more flexible or malleable, while remaining good electric conductors.

It is known to use metallized dielectric plastic films as electrodes in electrostatic condensers. The metals generally deposited on plastic films are in this case aluminum, zinc and their alloys. These metallizations are generally obtained, under vacuum, by thermal evaporation or by other assisted processes of evaporation: cathodic projection or electron beam. The thickness thus obtained is however very low, typically 100-500 Å and the surface resistance is consequently very high, approximately 1-100 Ω/square. In addition to the fact that the metals known and deposited are not chemically stable with the anode of polymer electrolyte generators, the surface conductivities obtained are insufficient to permit the draining of the range of currents provided for the average or large-size generators. The processes of metallization under vacuum are also known to be limited to a thickness lower than about 750 Å. These electrodes of electrostatic condensers are therefore not applicable as current collectors for most of the polymer electrolyte lithium generators, except possibly in the case of the metallization of aluminum applied to a positive electrode in small size batteries, where the mean current densities (Iₘₑₐₙ/cm²) are low.

U.S. Pat. Nos. 5,423,110 and 5,521,028 both disclose a current collector and a process for making same in which one metal is deposited under vacuum on an insulating support film of synthetic resin, the metal for the metallization being selected so as to constitute a substrate promoting an electrochemical deposit and having its thickness adjusted between about 0.005 and 0.01 μm in order to give a metallized film having sufficient electric conductivity to initiate a uniform electrochemical deposit. Also disclosed is the step of electrochemically depositing at least one additional metallic layer, of a total thickness between 0.1 and 4 μm, on at least one part of the surface of the metallized film so as to constitute a metallized-plate conductor and to reduce the electrical surface resistance of the collector at a level sufficient to prevent significant voltage losses by resistive effect in the collector during operation of the generator. The metal of the additional metallic layer deposited is selected for its compatibility with the corresponding electrode of the generator.

The applicant's co-pending U.S. application Ser. No. 10/329,364 discloses a current collector made of a polymer substrate support film having a thickness of between 1 and 15 μm; a conductive metallic layer having a thickness of less than 3 μm, which is coated by metal vapor deposition onto preferably both sides of the polymer substrate film which are able to conduct high current densities; and a protective metal or metal oxide layer deposited onto each conductive metallic layer, this protective layer being electrically conductive and having a thickness of between 5 and 500 nm for protecting the conductive metallic from the corrosive effects of the polymer electrolyte cells components.

The advantages of a current collector as described in co-pending U.S. application Ser. No. 10/329,364 are numerous, and include being lightweight, providing a very thin film, having resilience and having high current density conductivity. However, one draw back of this configuration is the fact that the polymer substrate support film may act as electrical insulation between its two conductive metallic layers, making it difficult to electrically connect two or more such current collectors, especially in parallel.

There is therefore a need for an electrical contact and method adapted to electrically connect two or more current collectors having conductive metallic layers over a polymer substrate support film.

### STATEMENT OF THE INVENTION

It is an object of the present invention to provide an electrical contact for current collectors having conductive metallic layers over a polymer substrate support film.

It is another object of the present invention to provide a method for electrically connecting two or more current collectors having conductive metallic layers over a polymer substrate support film.

It is a further object of the present invention to provide an electrical contact for current collectors having conductive metallic layers over a polymer substrate support film for use in electrochemical generators.

As embodied and broadly described, the invention provides an electrical contact for connecting current collecting elements of a plurality of stacked electrochemical laminates, said electrical contact comprising:
a current collecting terminal having a pair of arms, said arms defining therebetween a space in which the ends of the current collecting elements are received; and
a ductile electrically conductive material located within said space, said ductile electrically conductive material adapted to form an electrical bridge between the ends of said current collecting elements and said current collecting terminal.

As embodied and broadly described, the invention also provides an electrochemical generator comprising:
a plurality of stacked electrochemical laminates, each electrochemical laminate including:
   a) at least one electrolyte separator disposed between an anode film and a cathode film;
   b) a current collecting element associated with one of said anode film and said cathode film, said current collecting element comprising a polymer substrate support film coated on both sides with a conductive metallic layer;
a current collecting terminal having a pair of arms defining therebetween a space in which the ends of said current collecting elements are received, said current collecting terminal being crimped onto the ends of the current collecting elements;
a ductile electrically conductive material located within said space, said ductile electrically conductive material filling at least a portion of said space thereby forming an electrical bridge between the ends of said current collecting elements and said current collecting terminal.

As embodied and broadly described, the invention also provides a method of connecting in parallel the current collecting elements of a plurality of electrochemical laminates, said method comprising:
a) stacking the current collecting elements;
b) applying a layer of ductile electrically conductive material on at least a portion of the inside surface of a current collecting terminal, the current collecting terminal having a pair of arms defining a space therebetween;
c) positioning the ends of the current collecting elements as stacked within the space defined by the pair of arms of the current collecting terminal; and
d) crimping said current collecting terminal onto the ends of the current collecting elements.

### BRIEF DESCRIPTION OF THE DRAWINGS

The invention will be better understood and other advantages will appear by means of the following description and the following drawings in which:

FIG. 1 is an enlarged schematic cross-sectional view of an example of a metallized current collector of an electrochemical cell laminate;

FIG. 2 is an enlarged schematic side elevational view of an example of a series of metallized current collectors connected together in parallel;

FIG. 3 is an enlarged schematic side elevational view of an electrochemical cell comprising a series of laminates, wherein the current collectors are connected together in accordance with an embodiment of the present invention;

FIG. 3A is a enlarged schematic side view of the current collecting terminal of the electrochemical cell shown in FIG. 3;

FIG. 4 is a schematic perspective view of a current collecting terminal for an electrochemical cell prior to assembly in accordance with an embodiment of the present invention;

FIG. 5 is an enlarged schematic cross-sectional view of a series of current collectors connected together in accordance with a second embodiment of the present invention;

FIG. 6 is a schematic top plan view of a metallized current collector sheet in accordance with an embodiment of the present invention;

FIG. 7 is an enlarged schematic side perspective view of a series of laminates comprising metallized current collectors as shown in FIG. 5, stacked together to form an electrochemical cell in accordance with another embodiment of the present invention;

FIG. 8 is an enlarged schematic side perspective view of a series of laminates comprising another embodiment of a metallized current collector, stacked together to form an electrochemical cell;

FIG. 8A is an enlarged cross-sectional view of the stacked metallized current collectors shown in FIG. 8;

FIG. 8B is an enlarged cross-sectional view of a variant of the stacked metallized current collectors shown in FIG. 8;

FIG. 8C is an schematic cross-sectional view of the stacked metallized current collectors shown in FIGS. 8 and 8A showing the electrical contact paths;

FIG. 9 is an enlarged schematic side perspective view of a metallized current collector in accordance with another embodiment of the present invention;

FIG. 9A is an enlarged schematic cross-sectional view of the metallized current collector shown in FIG. 9;

FIG. 10 is an enlarged schematic side perspective view of a metallized current collector in accordance with another embodiment of the present invention; and

FIG. 10A is an enlarged schematic cross-sectional view of the metallized current collector shown in FIG. 10.

### DETAILED DESCRIPTION

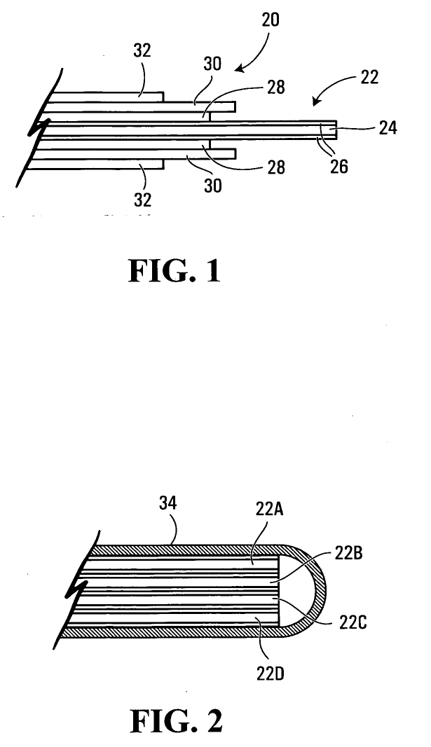

Current collectors in electrochemical cells are necessary passive components, responsible for transporting electrical current generated by the electrochemical reaction between the anode and the cathode. Current collectors are also necessary as mechanical supports for paste-like anodes or cathodes and as such should be as strong and as thin as practicable, in order to reduce the mass and volume penalty of the current collector to the overall weight and volume of the electrochemical cell. FIG. 1 illustrates schematically a cross-section of an example of an electrochemical cell laminate 20 comprising a metallized current collector 22, where this current collector 22 consists of a polymer substrate support film 24 having a metallic conductive layer 26 on each side thereof. The illustrated cell laminate 20 is a bi-face configuration and therefore comprises two layers of cathode material 28 as well as a pair of anode films 32. Each layer of cathode material 28 is coated or directly extruded onto a respective side of the current collector 22. Each anode file 32 is separated from a respective cathode layer 28 by an electrolyte separator 30. The anode films 32 are laterally offset relative to the cathode current collector 22, such that the anodes 32 extend from one end of the laminate 20 and the cathode current collector 22 extends at the other end of the laminate 20. As a result, when a plurality of cell laminates 20 are stacked together, all cathode current collectors 22 may be connected together in parallel at one end of the cell stack and all anode films 32 may be connected together in parallel at the other end of the cell stack.

In a specific example of an electrochemical cell laminate 20 construction, the anode films 32 are thin sheets of lithium or lithium alloy, while the cathode films or layers 28 are composites formed of a mixture of an insertion material capable of occluding and releasing lithium ions, such as transitional metal oxide, and an electrically conductive filler, such as carbon or graphite particles. Furthermore, the electrolyte separators 30 consist of a polymer/alkali metal salt complex that is ionically conductive.

The current collector 22 is formed of a very thin polymer support film 24 having a thickness of between 1 and 15 microns, preferably less than 10 microns, onto which are coated conductive metallic layers 26. Each metallic layer 26 has a thickness of between 0.1 and 5 microns, preferably about 0.3 to 1 micron. The conductive metallic layers 26 may be further protected against corrosion by a second extremely thin layer having a thickness of between 5 and 500 nanometers, preferably less than 100 nanometers. Preferred methods of depositing the conductive metal layers 26 in thickness sufficient to permit the draining of current densities (Iₘₐₓ/cm²) generated by average or large-size electrochemical cells include vacuum metal vapor deposition and plasma activated vapor deposition.

Typically, the substrate support film 24 is selected from the group consisting of: bi-axially oriented polystyrene (BO-PS), polyethylene terephthalate (BO-PET), polycarbonate (PC), polypropylene (PP), polypropylene sulphide (PPS) and polyethylene Naphthalate (PEN), amongst others. The conductive metallic layers 26 may be formed of any metal exhibiting good electrical and thermal conductivity, as well as low density and low cost. Suitable conductive metals are Aluminum (Al), Copper (Cu), Silver (Ag), Nickel (Ni) and Tin (Sn), or alloys based on these metals. However, Aluminum and Copper are preferred for their low cost and excellent conductivity and, in the case of Aluminum, for its lightness. Any of these metals may be vacuum vapor deposited or plasma activated deposited onto the polymer substrate film.

The polymer support film 24 is generally not a good electric conductor. As such, when three or more metallized current collectors 22 are electrically connected in parallel by a metallic current collecting terminal 34 crimped onto the ends of the current collectors 22, as shown in FIG. 2, only the surfaces of the current collectors 22A and 22D directly in contact with the current collecting terminal 34 are in electrical contact with the current collecting terminal 34. Current collectors 22B and 22C, as well as the surfaces of the current collectors 22A and 22D not directly in contact with the current collecting terminal 34, are electrically isolated and unable to conduct the electrochemical energy generated by their respective laminates. The polymer support film 24 of each metallized current collector 22A, 22B, 22C and 22D acts as an electrical insulator.

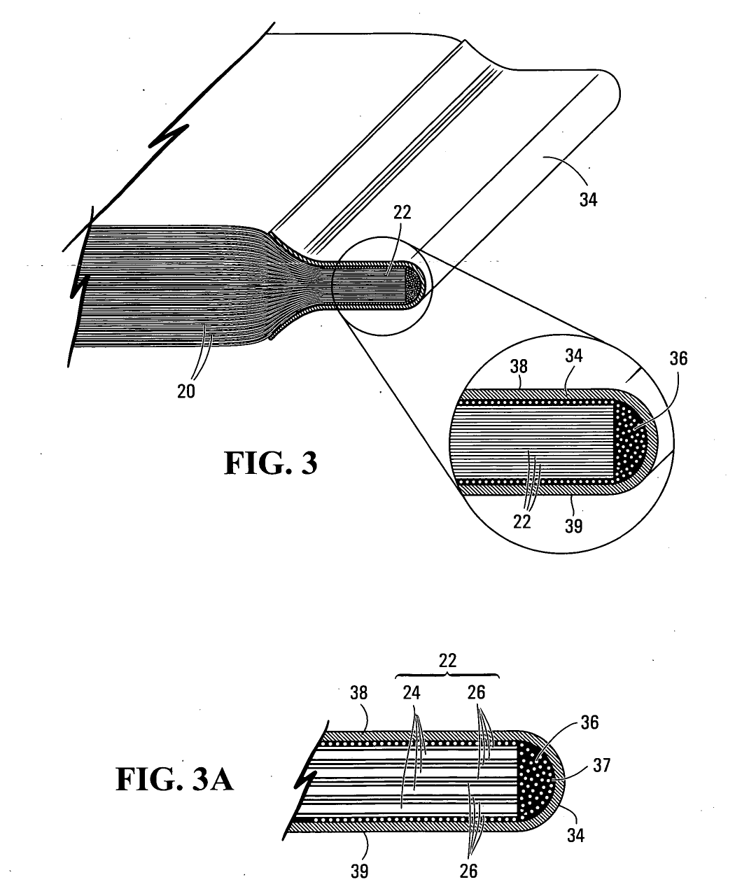

FIG. 3 illustrates a first, non-limiting embodiment of the present invention, wherein a plurality of electrochemical cell laminates are stacked together, their respective metallized current collectors 22 being electrically connected together with a current collecting terminal 34 crimped thereto. Inside the collecting terminal 34, between the inner surface of the collecting terminal 34 and the metallized current collectors 22, there is provided a ductile electrically conductive material 36. This ductile material 36 forms an electrical bridge between current collectors 22 and current collecting terminal 34, and more specifically between the ends of the current collectors 22 not directly in contact with the inner surfaces of the arms 38 and 39 of current collecting terminal 34.

As illustrated in FIG. 3A, the ends of the metallic conductive layers 26 of each metallized current collector 22 are in contact with the ductile electrically conductive material 36, which is itself in contact with the inner surfaces of current collecting terminal 34. As such, electrical current generated by each electrochemical cell laminate may circulate freely to current collecting terminal 34.

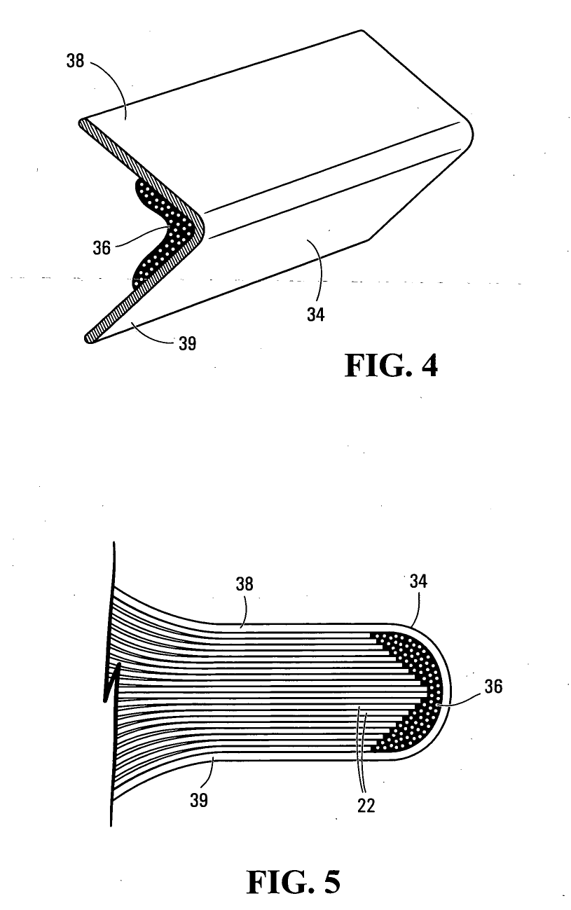

FIG. 4 illustrates a current collecting terminal 34 prior to being deformed and crimped onto the ends of the current collectors 22 of a stack of electrochemical cell laminates. The arms 38 and 39 of the current collecting terminal 34 are open wide enough to easily receive a stack of metallized current collectors 22. A portion of the inner surface of the current collecting terminal 34 is covered with a layer of ductile electrically conductive material 36 prior to deformation or crimping. When the current collecting terminal 34 is deformed or crimped onto the stack of metallized current collectors 22, the ductile electrically conductive material 36 saturates the volume created by the arms 38 and 39 of current collecting terminal 34, and more specifically the void space 37 (FIG. 3A), thus forming an electrical bridge between the ends of metallized current collectors 22 and current collecting terminal 34. The ductile electrically conductive material 36 may also partially penetrate between the metallized current collectors 22 when the arms 38 and 39 of current collecting terminal 34 are pressed and crimped onto the stack of metallized current collectors 22, thereby providing more surface area through which electrical current may circulate.

The ductile electrically conductive material 36 may be a metal that is very ductile at room temperature, such as lithium, tin, lead, alloys thereof or combinations thereof, among other possibilities. The ductile material 36 may also be a metal-based epoxy paste, such as silver or aluminium epoxy-based paste, or any other suitable conductive paste.

FIG. 5 illustrates a second embodiment of the invention wherein, within the stack of electrochemical cell laminates, the metallized current collectors 22 are stacked in a stair-like or offset pattern. This stacking pattern leaves a portion of the conductive metal layers 26 of each metallized current collector 22 exposed, thereby providing an increased surface area through which electrical current may circulate.

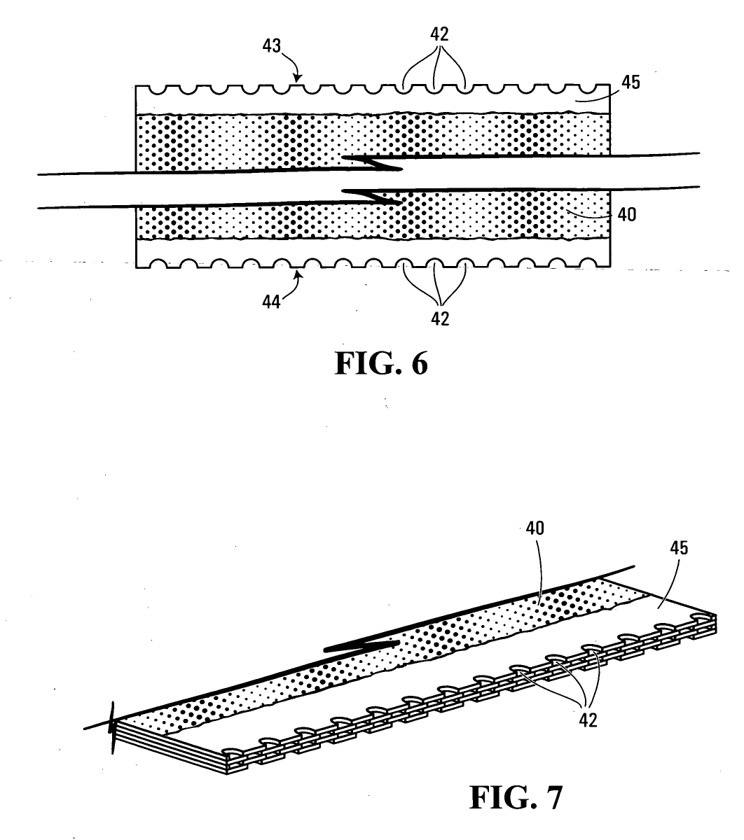

According to yet another embodiment of the present invention, FIG. 6 is a top plan view of a metallized current collector sheet 45 onto which is coated a layer of cathode material 40. The edges 43 and 44 of the metallized current collector sheet 45 are provided with a series of indentations 42 made prior to coating of the current collector sheet 45 with the cathode material 40. Since only one edge (43 or 44) of the metallized current collector sheet 45 will be connected to another metallized current collector sheet 45, it is sufficient to have indentations 42 made on one of the two edges 43 or 44. Furthermore, the indentations 42 may be cut out after the cathode material 40 has been coated onto the metallized current collector sheet 45.

FIG. 7 illustrates the positive side of a stack of electrochemical cell laminates comprising a plurality of cathodes having metallized current collector sheets 45 as illustrated in FIG. 6. The series of indentations 42 have the effect of increasing the surface area of the ends of the metallized current collector sheets 45 in contact with the ductile electrically conductive material 36, when these same ends of the metallized current collector sheets 45 are crimped together. More specifically, the overall length of the exposed ends of the metallic conductive layers 26 of all metallized current collector sheets 45 is increased, thereby increasing the total surface area in contact with the ductile electrically conductive material 36. Furthermore, the indentations 42 expose portions of the sides of adjacent metallized current collector sheets 45, thereby further increasing the total surface area of the metallic conductive layers 26 in contact with the ductile electrically conductive material 36. The indentations 42 provide more surface area through which electrical current may circulate.

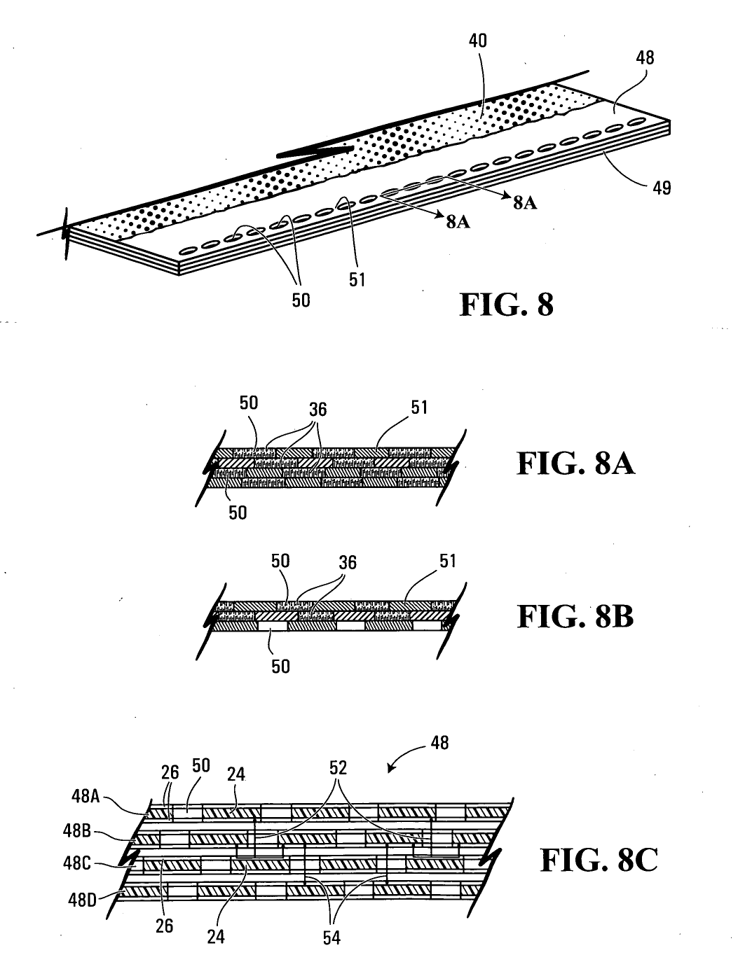

FIG. 8 illustrates a further embodiment of the present invention, wherein cathode layers 40 are coated onto metallized current collector sheets 48 that are provided at one edge 49 with a series of perforations 50. Perforations 50 allow ductile electrically conductive material 36 to infiltrate the various layers of metallized current collector sheets 48. Perforations 50 also provide for direct contact between a first metallic conductive layer 26 of a first metallized current collector sheet 48 and a third metallic conductive layer 26 of a third metallized current collector sheet 48, through the perforations 50 of a second metallized current collector sheet 48 located between the first and third metallized current collector sheets 48.

FIG. 8A is a cross-sectional view taken at line 8A-8A of FIG. 8 and illustrates ductile electrically conductive material 36 infiltrating all of the perforations 50. If the distance 51 between two adjacent perforations 50 is smaller than the diameter of the perforations 50, the ductile electrically conductive material 36 will infiltrate the perforations 50 of the subsequent metallized current collector sheets 48 even with a random alignment of the perforations 50 as shown in FIG. 8A.

FIG. 8B is also a cross-sectional view taken at line 8A-8A of FIG. 8 and illustrates a situation in which the ductile electrically conductive material 36 is unable to infiltrate all of the perforations 50 because the distance 51 between two adjacent perforations 50 is greater than the diameter of the perforations 50 themselves. In this case, a random alignment of the perforations 50 may prevent the ductile electrically conductive material 36 from infiltrating some of the subsequent metallized current collector sheets 48.

FIG. 8C is further a cross-sectional view taken at line 8A-8A of FIG. 8, which illustrates in more detail the various layers of the metallized current collector sheets 48 and the electrical contacts between them. When pressure is applied onto the stack of metallized current collector sheets 48 with the jaws of a crimping apparatus, the polymer substrate 24 may be deformed or compressed to such an extent that the conductive layer 26 of a first metallized current collector sheet 48 may physically reach through the perforations 50 of a second metallized current collector sheet 48 and contact the conductive layer 26 of a third metallized current collector sheet 48. This phenomenon is illustrated in FIG. 8C by the electrical paths 52 and 54. Electrical paths 52 show that the conductive layer 26 of metallized current collector sheet 48A is in contact with the conductive layer 26 of metallized current collector sheet 48C, which is in turn in direct contact with the conductive layer 26 of metallized current collector sheet 48B. Furthermore, electrical paths 54 show that the conductive layer 26 of metallized current collector sheet 48B is in contact with the conductive layer 26 of metallized current collector sheet 48D, also through the deformation or compression of the polymer substrate 24 of metallized current collector sheet 48C. The combination of the infiltration of ductile conductive material through the perforations 50 and the compression and deformation of the polymer substrate 24 of the various metallized current collector sheets 48 increases the electrical contacts between the plurality of crimped metallized current collector sheets 48 of an electrochemical cell.

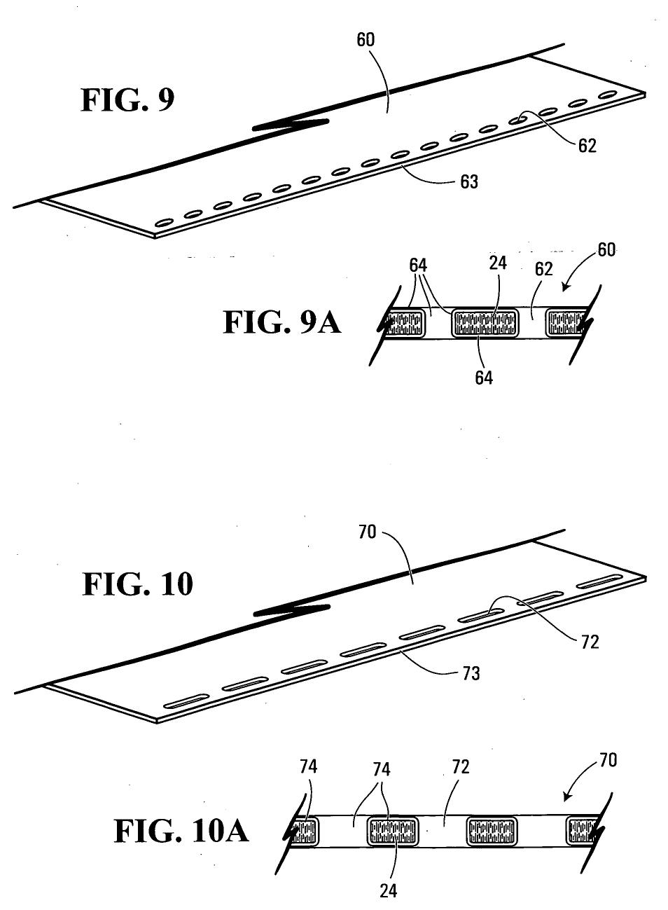

FIG. 9 illustrates another embodiment of the present invention, wherein a metallized current collector sheet 60 is provided with perforations 62 along its edge 63. As shown in FIG. 9A, the perforations 62 are made to the polymer substrate 24 prior to applying the metallic conductive layers 64, such that the inner surfaces of the perforations 62 are also coated with a metallic conductive layer 64. The metallic conductive layers 64 on both sides of the metallized current collector sheet 60 are therefore in electrical contact with each other through the metallic conductive layers 64 of the inner surfaces of the perforations 62. The parallel electrical connections of a plurality of metallized current collector sheets 60 therefore offer less resistance, since there is an electrical path provided through the polymer substrate 24 between the metallic conductive layers 64 on opposite sides of each metallized current collector sheet 60. The use of a ductile conductive material 36 with a crimped current collecting terminal to effect the parallel electrical connection, as well as the compression or deformation of the polymer substrate layer 24, provide a further increase in the electrical conductivity of the various metallized current collector sheets 60 within the current collecting terminal.

FIG. 10 illustrates a variant of the embodiment shown in FIG. 9, wherein a metallized current collector sheet 70 comprises oblong perforations 72 made along its edge 73. As shown in FIG. 10A, the inner surfaces of the perforations 72 are also coated with a metallic conductive layer 74. The metallic conductive layers 74 on both sides of the metallized current collector sheet 70 are therefore in electrical contact with each other through the metallic conductive layers 74 of the inner surfaces of the perforations 72. The oblong perforations 72 provide an increased contact area between the metallic conductive layers 74 of both sides of the metallized current collector sheet 70.

The embodiments of metallized current collector sheets 45, 48, 60 and 70 as illustrated in FIGS. 6, 7, 8, 9 and 10 may also be stacked and crimped together in a stair-like or offset pattern as illustrated in FIG. 5, thereby leaving a greater portion of the conductive metal layers of each metallized current collector sheets exposed to the ductile electrically conductive material and providing increased total surface area through which electrical current may circulate.

In a further embodiment (not shown), it is also possible to first stack the metallized current collector sheets as illustrated in FIG. 3 and, prior to crimping the assembly, to punch a series of perforations as illustrated in FIG. 8 such that the perforations will be aligned. As a result, the ductile electrically conductive material will penetrate and fill the perforations, thereby providing electrical contact within the perforations as well as outside of the perforations.

Although the present invention has been described in relation to particular embodiments thereof, other variations and modifications are contemplated and are within the scope of the present invention. Therefore, the present invention is not to be limited by the above description but is defined by the appended claims.

1- An electrical contact for connecting current collecting elements of a plurality of stacked electrochemical laminates, said electrical contact comprising:
a current collecting terminal having a pair of arms, said arms defining therebetween a space in which the ends of the current collecting elements are received; and
a ductile electrically conductive material located within said space, said ductile electrically conductive material adapted to form an electrical bridge between the ends of said current collecting elements and said current collecting terminal.

2- An electrical contact as defined in claim 1, wherein the pair of arms of said current collecting terminal are crimped onto the ends of the current collecting elements and said ductile electrically conductive material fills at least a portion of said space between said pair of arms.

3- An electrical contact as defined in claim 2, wherein the ends of said current collecting elements of said electrochemical laminates are stacked together in a stepped pattern thereby exposing a portion of one side of each of said current collecting elements to said ductile electrically conductive material.

4- An electrical contact as defined in claim 2, wherein the end of each current collecting element within said stack of electrochemical laminates comprises a series of indentations adapted to increase the surface area of the respective current collecting element that is in contact with said ductile electrically conductive material.

5- An electrical contact as defined in claim 2, wherein the end of each current collecting element within said stack of electrochemical laminates comprises a series of perforations.

6- An electrical contact as defined in claim 5, wherein said series of perforations are partially filled with ductile electrically conductive material.

7- An electrical contact as defined in claim 5, wherein a first current collecting element is in contact with a third current collecting element via the perforations of a second current collecting element located between said first and third current collecting elements.

8- An electrical contact as defined in claim 5, wherein the shape of the perforations is selected from the group consisting of circular, oblong, square, rectangular or combinations thereof.

9- An electrical contact as defined in claim 5, wherein the walls of each perforation are coated with an electrically conductive layer.

10- An electrical contact as defined in claim 1, wherein said ductile electrically conductive material is selected from the group consisting of lithium, tin, lead, alloys thereof, combinations thereof and metal-based paste.

11- An electrochemical generator comprising:
a plurality of stacked electrochemical laminates, each electrochemical laminate including:
a) at least one electrolyte separator disposed between an anode film and a cathode film;
b) a current collecting element associated with one of said anode film and said cathode film, said current collecting element comprising a polymer substrate support film coated on both sides with a conductive metallic layer;
a current collecting terminal having a pair of arms defining therebetween a space in which the ends of said current collecting elements are received, said current collecting terminal being crimped onto the ends of said current collecting elements;
a ductile electrically conductive material located within said space, said ductile electrically conductive material filling at least a portion of said space thereby forming an electrical bridge between the ends of said current collecting elements and said current collecting terminal.

12- An electrochemical generator as defined in claim 11, wherein the ends of said current collecting elements of said electrochemical laminates are stacked together in a stepped pattern thereby exposing a portion of one side of each of said current collecting elements to said ductile electrically conductive material.

13- An electrochemical generator as defined in claim 11, wherein the end of each current collecting element within said stack of electrochemical laminates comprises a series of indentations adapted to increase the surface area of the respective current collecting element that is in contact with said ductile electrically conductive material.

14- An electrochemical generator as defined in claim 11, wherein the end of each current collecting element within said stack of electrochemical laminates comprises a series of perforations, each perforation being at least partially filled with said ductile electrically conductive material.

15- An electrochemical generator as defined in claim 11, wherein the end of each current collecting element within said stack of electrochemical laminates comprises a series of perforations, such that a first current collecting element is in contact with a third current collecting element via the perforations of a second current collecting element located between said first and third current collecting elements.

16- An electrochemical generator as defined in claim 11, wherein said ductile electrically conductive material is selected from the group consisting of lithium, tin, lead, alloys thereof, combinations thereof and metal-based paste.

17- A method of connecting in parallel the current collecting elements of a plurality of electrochemical laminates, said method comprising:
a) stacking the current collecting elements;
b) applying a layer of ductile electrically conductive material on at least a portion of the inside surface of a current collecting terminal, the current collecting terminal having a pair of arms defining a space therebetween;
c) positioning the ends of the current collecting elements as stacked within the space defined by the pair of arms of the current collecting terminal; and
d) crimping said current collecting terminal onto the ends of the current collecting elements.

18- A method as defined in claim 17, further comprising the step of forcing said ductile electrically conductive material to spread between adjacent current collecting elements within the stack of current collecting elements.
